(19) United States
(12) Patent Application Publication
(10) Pub. No.: US 2024/0262754 A1
(43) Pub. Date: Aug. 8, 2024

(54) SINTERED BALLS MADE OF TUNGSTEN CARBIDE

(71) Applicant: SAINT-GOBAIN CENTRE DE RECHERCHES ET D'ETUDES EUROPEEN, COURBEVOIE (FR)

(72) Inventors: David BOUTTES, AVIGNON (FR); Yves Marcel Léon BOUSSANT-ROUX, MONTFAVET (FR); Emmanuel NONNET, SAINT-SATURNIN LES AVIGNON (FR); Gilles ROSSIQUET, LOUZAC SAINT-ANDRE (FR); Stephen BOTTIGLIERI, NORTHBRIDGE, MA (US)

(21) Appl. No.: 18/637,149

(22) Filed: Apr. 16, 2024

Related U.S. Application Data
(63) Continuation of application No. 17/283,527, filed on Apr. 7, 2021, now abandoned.

(30) Foreign Application Priority Data
Oct. 9, 2018 (FR) 1859340

(51) Int. Cl. C04B 35/56; B22F 1/065; C04B 35/64; C22C 29/08

(52) U.S. Cl. CPC C04B 35/5626; B22F 1/065; C04B 35/64; C22C 29/08; C04B 2235/3847; C04B 2235/656; C04B 2235/725; C04B 2235/77; C04B 2235/785; C04B 2235/786

(57) ABSTRACT

Use, as a milling agent for milling a suspension, wet dispersing agent or for surface treatment, of a powder comprising more than 90% by mass of sintered balls, each sintered ball having: a chemical composition such that, in percentages by mass based on the mass of the ball: 89%≤W≤97%; 5%≤C≤8%; Co≤0.5%; Ni≤0.5%; Elements other than W, C, Co, and Ni, or “Other elements”: ≤3%; a tungsten carbide(s) content greater than 55% in percentage by mass based on the crystallized phases; a bulk density greater than or equal to 14 g/cm³.

### TECHNICAL FIELD

The present invention relates to a sintered ball made of tungsten carbide(s), to a powder comprising more than 90% by mass of said balls, to a process for manufacturing said balls, and to the use of said balls, in particular as milling agents.

### PRIOR ART

The mineral or mining industry uses balls for the fine milling of materials that may first be dry milled by conventional processes, in particular for the fine milling of calcium carbonate, titanium oxide, gypsum, kaolin and ore containing metals in generally combined form (oxides, sulfides, silicates, etc.), processes which may also involve prior purification methods, for example by flotation.

All these balls conventionally have a size of 0.03 to several mm and, in particular, they must have good wear resistance.

In order to further improve the milling efficiency, the use of sintered balls made of a material having a high density, such as tungsten carbide, can be considered. The higher density also facilitates the separation of the particles from the suspension to be milled.

Cobalt and/or nickel are generally used as a metallic binder in the manufacture of sintered balls made of tungsten carbide(s) and allow the sintering temperature to be lowered.

The wear generated during the use of said balls has in particular the effect of releasing cobalt and/or nickel compounds, said compounds which can cause problems of pollution of the milled or homogenized material, or even hygiene and environmental problems. Similarly, hygiene and environmental problems may be encountered during the manufacture of said balls.

There is a need for novel sintered balls made of tungsten carbide(s), which are in particular suitable for use as milling balls and whose use limits the hygiene and environmental problems and/or the problems of pollution of the milled material.

There is also a need for a process for manufacturing such balls that is simple and economical to implement.

One purpose of the invention is to address, at least partially, these needs.

### SUMMARY OF THE INVENTION

The invention proposes a sintered ball having:
the following chemical composition, in percentages by mass based on the mass of the ball:
   89%≤W≤97%;
   5%≤C≤8%;
   Co≤0.5%;
   Ni≤0.5%;
   Elements other than W, C, Co and Ni, or “Other elements”: ≤3%;
a tungsten carbide(s) content greater than 55%, in percentage by mass based on the crystallized phases;

a bulk density greater than or equal to 14 g/cm³.

Preferably, the tungsten carbide(s) content is greater than 80%, in percentage by mass based on the crystallized phases.

Preferably, the chemical composition contains less than 0.01% boron, preferably no boron, and the tungsten carbide(s) content is greater than 80%, in percentage by mass based on the crystallized phases.

As will be seen in more detail hereinbelow, the inventors discovered, unexpectedly, that this combination of features makes it possible to solve the technical problem posed.

The balls according to the invention are thus particularly well suited to micromilling applications. They can also be used in wet dispersion applications and in surface treatment.

A ball according to the invention may further include one or more of the following optional features:
W>90% and/or W<96% or W<95%, and/or
C>5.5% or C>5.9% and/or C<7.5% or C<7.0%, and/or
Co<0.3% or Co<0.1%, and/or
Ni<0.3% or Ni<0.1%, and/or
Fe<0.5%, and/or
other elements<2.5% or <2%, and/or
the tungsten carbide(s) content is greater than 85% or greater than 95% in percentage by mass based on the crystallized phases;
0.01%<Ti+Ta+B+Cr+Nb+Mo+V<2.5%;
the bulk density is greater than or equal to 14.3 g/cm³ or greater than or equal to 14.6 g/cm³;
Zr<0.17% or Zr<0.1%;
0.2%<Ti<2.5%;
0.2%<Ta<2.5%;
in an embodiment, 0.1%<Ti<1.5% and 0.2%<Ta<2%;
0.01%<B<2.5%;
the ball has a sphericity greater than 0.90;
in an embodiment, WC and W₂C together represent more than 85% of the mass of all the crystallized phases of the ball;
the ball is made of grains and has an average grain size greater than or equal to 0.1 μm and/or less than or equal to 30 μm.

The invention also relates to a powder comprising more than 90% by mass of sintered balls according to the invention, preferably substantially 100% of sintered balls according to the invention.

The invention also relates to a process for manufacturing a powder according to the invention, said process comprising the following steps:
a) preparation of a feedstock so that the ball powder obtained at the conclusion of step
   c) conforms to the invention,
b) shaping of the feedstock into a raw ball powder,
c) sintering so as to obtain a sintered ball powder.

A process according to the invention may further include one or more of the following optional features:
in step a), the feedstock comprises a WC powder and, optionally, one or more carbon, titanium carbide, tantalum carbide, boron carbide, vanadium carbide, molybdenum carbide, chromium carbide, niobium carbide and tungsten oxide powders, said powders which may be replaced, at least partially, by precursor powders, introduced in equivalent amounts, the median size of all the particles of said powders, preferably the median size of each said powder being less than 2 μm, preferably less than 1 μm, preferably less than 0.5 μm;
preferably, in the feedstock, Co<0.2%, preferably Co<0.1%, preferably Co<0.05%, preferably the Co content is substantially zero, in percentages by mass based on said feedstock;
preferably, in the feedstock, Ni<0.2%, preferably Ni<0.1%, preferably Ni<0.05%, preferably the Ni content is substantially zero, in percentages by mass based on said feedstock;
preferably in the feedstock, Fe<0.5%, preferably Fe<0.4%, preferably Fe<0.3%, preferably Fe<0.2%, preferably Fe<0.1%, in percentages by mass based on said feedstock;
preferably, the shaping in step b) is carried out at less than 2 bar, less than 1.5 bar, less than 1.1 bar, preferably at a pressure of 1 bar, preferably at atmospheric pressure;
preferably, the sintering temperature in step c) is greater than 1700° C., preferably greater than 1800° C., preferably greater than 1900° C. and preferably less than 2300° C.;
preferably, the sintering in step c) is carried out at less than 2 bar, less than 1.5 bar, less than 1.1 bar, preferably at a pressure of 1 bar, preferably at atmospheric pressure;
preferably, the duration of the sintering stage in step c) is greater than 0.5 hour, preferably greater than 1 hour and/or less than 5 hours, preferably less than 4 hours, preferably less than 3 hours, or even less than 2 hours;
preferably, in step c), the sintering is carried out in an inert or reducing atmosphere.

Remarkably, a median size for all particles of the feedstock of less than 2 μm makes it possible to obtain sintered balls having a bulk density greater than or equal to 14.0 g/cm³, preferably greater than or equal to 14.3 g/cm³, preferably greater than or equal to 14.5 g/cm³, preferably greater than or equal to 14.6 g/cm³, preferably greater than or equal to 15 g/cm³, with very low, or even zero, nickel and/or cobalt contents,
without the need to strongly press the feedstock in step b) and
without the need to resort to high-pressure heat treatment, such as hot isostatic pressing (HIP) or hot pressing (HP), during the sintering step c).

In an embodiment, the process according to the invention does not include a pressing operation in step b) or in step c), preferably in step b) and step c).

The manufacturing process is considerably simplified, in particular for the production of balls.

Finally, the invention relates to the use of a powder according to the invention as a milling agent, a wet dispersing agent or for the treatment of surfaces, in particular ceramic or metallic surfaces.

### Definitions

“Ball” means a particle having a sphericity, i.e., a ratio between its smallest Ferret diameter and its largest Ferret diameter, greater than or equal to 0.75, regardless of the way in which this sphericity has been obtained.

“Ball powder” means a powder containing more than 90% by mass of balls.

“Sintered ball” means a ball obtained by mixing appropriate raw materials and then shaping this mixture raw and firing the resulting raw ball at a temperature and for a time sufficient to sinter this raw ball. A sintered ball is made up of “grains” bonded together during sintering.

In the context of this application, “tungsten carbide(s)” refers to any carbide containing more than 75% by mass of the element W, and in particular WC, W₂C, and carbides of tungsten and titanium having a cubic crystallographic structure, and carbides of tungsten and tantalum having a cubic crystallographic structure.

The “size” of a powder particle is conventionally its dimension measured by means of a laser particle size analyzer.

“Percentiles” 50 (denoted D₅₀), 10 (denoted D₁₀), 90 (denoted D₉₀) and 99.5 (denoted D_{99.5}) refer to the particle or ball sizes corresponding to percentages equal respectively to 50%, 10%, 90% and 99.5%, by mass, on the cumulative particle size distribution curve of the powder particle or ball sizes, said particle or ball sizes being ranked in ascending order. According to this definition, 99.5% by mass of the powder particles or balls have a size less than D_{99.5} and 0.5% of the particles or balls, by mass, have a size greater than or equal to D_{99.5}. The percentiles for the ball powders can be determined using a particle size distribution prepared with a Camsizer® XT marketed by the firm Horiba.

The “median size” of a particle or ball powder is called the 50 percentile. The median size thus divides the powder particles or balls into first and second populations equal in mass, these first and second populations comprising only particles or balls having a size greater than or equal to, or less than, respectively, the median size.

The “maximum size” of a particle or ball powder is called the 99.5 percentile.

The “median sphericity” of a powder divides the particles of this powder into first and second populations equal in mass, these first and second populations comprising only particles with a sphericity greater than, equal to, or less than, respectively, the median sphericity.

A total content of several carbides, for example WC+W₂C, does not imply that each of said carbides is present, even if, in an embodiment, each of said carbides is present.

The “bulk density” of a powder means the ratio between the mass of the powder and the cumulative volume of the powder particles, thus including the closed porosity located inside these particles.

A “precursor” of an element is a constituent that transforms into said element during the manufacture of a ball according to the invention.

The “average size” of the grains of a sintered ball is the dimension measured according to a “mean linear intercept” dimension. A measurement method of this type is described in standard ASTM E1382. The measurement can be performed on a section of the ball, as described in the examples. In general, the properties of the balls and powders according to the invention can be measured according to the methods described for the examples below.

To “contain”, “comprise”, or “have” should not be interpreted in a restrictive manner.

Unless otherwise stated, the percentages used to characterize a composition always refer to mass percentages based on said composition.

The mass contents of the phases (WC, W₂C, etc.) are measured on the basis of the total mass of the crystallized phases.

### DETAILED DESCRIPTION

### Process for Manufacturing Sintered Balls

To manufacture sintered balls according to the invention, it is possible to proceed according to a process comprising the steps a) to c) described above and detailed below.

In step a), a feedstock suitable for the shaping process of step b) is prepared, preferably at room temperature, as is well known to the person skilled in the art. The feedstock is adapted so that the ball powder obtained at the conclusion of step c) conforms to the invention. To this end, it comprises a particulate mixture of inorganic powders, preferably consisting of a WC powder and, optionally, one or more carbon, titanium carbide, tantalum carbide, boron carbide, vanadium carbide, molybdenum carbide, chromium carbide, niobium carbide and tungsten oxide powders.

These powders can also be replaced, at least partially, by precursor powders, introduced in equivalent amounts.

Impurities consist of the elements not intentionally introduced in the feedstock. The powders are preferably selected so that the total content of impurities excluding oxygen is less than 0.5%, preferably less than 0.3%, preferably less than 0.1%, in percentage by mass based on the particulate mixture of the feedstock.

The powders are preferably selected so that their median size is less than 2 μm, preferably less than 1 μm, preferably less than 0.5 μm. The powders can be milled or co-milled prior to step a) to this end, for example by impact and/or friction milling.

Preferably, the feedstock comprises one or more powders among a titanium carbide powder, a tantalum carbide powder, a boron carbide powder, a vanadium carbide powder, a molybdenum carbide powder, a chromium carbide powder, a niobium carbide powder, and precursor powders of these compounds. Preferably, the ratio of the median size of each of said powders, preferably all of said powders, to the median size of the tungsten carbide powder is less than 5, preferably less than 4, preferably less than 3, preferably less than 2, preferably less than 1, preferably less than 0.9, preferably less than 0.8, preferably less than 0.7, preferably less than 0.6, preferably less than 0.5.

In an embodiment, WC is the only tungsten carbide introduced in the feedstock.

Preferably, the feedstock has a mass ratio of W content to Ti+Ta+B+Cr+Nb+Mo+V content greater than 35.6, preferably greater than 44.5, preferably greater than 59, and less than 9700, preferably less than 1940, preferably less than 970, preferably less than 485.

In an embodiment, the feedstock has a mass ratio of W content to B content greater than 8900, and a mass ratio of W content to Ti+Ta+Cr+Nb+Mo+V content greater than 35.6, preferably greater than 44.5, preferably greater than 59, and less than 485, preferably less than 323, preferably less than 243, preferably less than 194.

Preferably in this embodiment, when WC is the only tungsten carbide introduced into the feedstock, when the feedstock contains a titanium carbide powder, and when the feedstock contains substantially no tantalum carbide, chromium carbide, niobium carbide, molybdenum carbide or vanadium carbide, the feedstock has a mass ratio of the amount of WC powder to the amount of titanium carbide powder greater than 30.3, preferably greater than 38, preferably greater than 51, and less than 413, preferably less than 275, preferably less than 207, preferably less than 165.

In an embodiment, the feedstock has a mass ratio of W content to Ti+Ta+Cr+Nb+Mo+V content greater than 890, and a mass ratio of W content to B content greater than 28, preferably greater than 35, preferably greater than 47, preferably greater than 70, preferably greater than 141, and less than 7663, preferably less than 1533, preferably less than 766, preferably less than 383.

Preferably in this embodiment, when WC is the only tungsten carbide introduced into the feedstock, when the feedstock contains B₄C powder, and when the feedstock contains substantially no titanium carbide, tantalum carbide, chromium carbide, niobium carbide, molybdenum carbide or vanadium carbide, the feedstock has a mass ratio of the amount of WC powder to the amount of B₄C powder greater than 23, preferably greater than 29, preferably greater than 39, preferably greater than 59, preferably greater than 117, and less than 6389, preferably less than 1278, preferably less than 639, preferably less than 319.

The WC content in the sintered ball can be adjusted by means of the carbon content in the feedstock. To increase the WC content in the sintered ball, the carbon content in the feedstock can be increased, for example by adding a carbon source, for example carbon black powder, an organic compound in powder or liquid form, preferably containing little or no oxygen, for example paraffin.

To increase the W₂C content and/or to decrease the free carbon content in the sintered ball, a tungsten metal powder and/or a tungsten carbide powder with a higher oxygen content and/or a tungsten oxide powder can be added to the feedstock.

The feedstock may include, in addition to the particulate mixture, a solvent, preferably water, the amount of which is suitable for the shaping method of step b). The feedstock may also include a dispersant, a plasticizer, a surface tension modifier, a gelling agent and/or an anti-foaming agent. These additives, well known to the skilled person, are suitable for the shaping method used in step b).

In step b), any conventional shaping process known for the manufacture of sintered balls can be used. Among these processes, mention may be made of:
granulation processes, using for example granulators, fluidized bed granulators, or granulation discs,
processes of atomization-drying of a slurry,
gelling processes,
injection molding or extrusion processes, and
pressing processes.

In an embodiment, steps a) and b) are at least partially merged, in particular when a solvent is gradually added during shaping.

In a preferred embodiment, step b) does not include pressing.

In step c), the raw balls are sintered in an inert atmosphere, such as argon or nitrogen for example, or a reducing atmosphere, such as in a hydrogen and/or carbon monoxide atmosphere, or in a vacuum.

Preferably sintering takes place in an electric furnace, preferably at atmospheric pressure.

As is well known, the sintering time and temperature allow adjustment of the bulk density of the resulting balls. It is also well known that the application of pressure during sintering can increase the bulk density of the resulting balls. As shown in the examples below, a low median size, however, makes it possible to obtain a bulk density according to the invention by shaping and sintering at room pressure.

Preferably, the sintering time is greater than 0.5 hour and/or less than 5 hours. Preferably, the sintering time is comprised between 1 and 2 hours.

The sintering in step c) is carried out at a temperature greater than 1700° C., preferably greater than 1800° C., preferably greater than 1900° C. and preferably less than 2300° C.

After the sintering step c), the sintered ball powder obtained can be subjected to an optional particle size sorting step, for example by sieving and/or air separation, configured to obtain a particle size distribution suitable for the intended use. The sintered ball powder can also undergo morphological sorting, for example by means of a spiral separator.

### Sintered Ball

A sintered ball according to the invention, and preferably a powder according to the invention, may have one or more of the following optional chemical composition features:
The tungsten W content is greater than 89.5%, preferably greater than 90%, preferably greater than 90.8%, preferably greater than 91% and/or less than 96%, preferably less than 95%, preferably less than 94.5%, preferably less than 94.1%;
The carbon C content is greater than 5.5%, preferably greater than 5.8%, preferably greater than 5.9% and/or less than 7.5%, preferably less than 7%, preferably less than 6.5%;
The cobalt Co content is less than 0.4%, preferably less than 0.3%, preferably less than 0.2%, preferably less than 0.1%, preferably less than 0.05%;
The nickel Ni content is less than 0.4%, preferably less than 0.3%, preferably less than 0.2%, preferably less than 0.1%, preferably less than 0.05%;
The content of elements other than W, C, Co, Ni, is less than 2.5%, preferably less than 2%, preferably less than 1.5%;
In an embodiment, the zirconium Zr content is less than 0.17%, preferably less than 0.16%, preferably less than 0.15%, preferably less than 0.1%, preferably less than 0.08%, preferably less than 0.05%. Advantageously, the bulk density of the sintered ball is increased;
In an embodiment, the iron Fe content is less than 0.5%, preferably less than 0.4%, preferably less than 0.3%, preferably less than 0.2%, preferably less than 0.1%;
Preferably, the Ti+Ta+B+Cr+Nb+Mo+V mass content is greater than 0.01%, preferably greater than 0.05%, preferably greater than 0.1%, preferably greater than 0.2%, and less than 2.5%, preferably less than 2%, preferably less than 1.5%;
In an embodiment, the B mass content is less than 0.01%, preferably substantially zero, and the Ti+Ta+Cr+Nb+Mo+V mass content is greater than 0.2%, preferably greater than 0.3%, preferably greater than 0.4%, preferably greater than 0.5% and less than 2.5%, preferably less than 2%, preferably less than 1.5%;
In an embodiment, in particular when a TiC powder is present in the feedstock in step b), the Ti mass content is a content greater than 0.2%, preferably greater than 0.3%, preferably greater than 0.4%, preferably greater than 0.5% and less than 2.5%, preferably less than 2%, preferably less than 1.5%;
In an embodiment, in particular when a TaC powder is present in the feedstock in step b), the Ta mass content is a content greater than 0.2%, preferably greater than 0.3%, preferably greater than 0.4%, preferably greater than 0.5% and less than 2.5%, preferably less than 2%, preferably less than 1.5%;
In an embodiment, in particular when a TiC powder and a TaC powder are present in the feedstock in step b), the Ti mass content is greater than 0.1%, preferably greater than 0.2%, preferably greater than 0.3%, preferably greater than 0.4% and less than 1.5%, preferably less than 1%, preferably less than 0.8%, and Ta is present in the other elements, in a content greater than 0.2%, preferably greater than 0.3%, preferably greater than 0.4%, preferably greater than 0.5% and less than 2%, preferably less than 1.5%, preferably less than 1.2%, the total Ti+Ta content preferably being less than 2.5%;
In an embodiment, in particular when a B₄C powder is present in the feedstock in step b), B is present in the other elements, in a content greater than 0.01%, preferably greater than 0.05%, preferably greater than 0.1%, preferably greater than 0.2% and less than 2.5%, preferably less than 2%, preferably less than 1.5%, preferably less than 1%, preferably less than 0.5%.

Preferably, the sintered ball has the following chemical composition, in percentages by mass based on the mass of the ball:
89%≤W≤95%;
5%≤C≤8%;
Co≤0.5%;
Ni≤0.5%;
other elements: ≤3%.

Preferably, the sintered ball has the following chemical composition, in percentages by mass based on the mass of the ball:
W>90% and W<94.5%, and/or
C>5.5% and C<7.5%, and/or
Co<0.3%, and/or
Ni<0.3%, and/or
Fe<0.5%, and/or
other elements <2.5%, and/or

the tungsten carbide(s) content is greater than 85% in percentage by mass based on the crystallized phases.

Preferably, the sintered ball has the following chemical composition, in percentages by mass based on the mass of the ball:
90.8%<W<94.1%, and/or
C>5.9% and C<7%, and/or
Co<0.1%, and/or
Ni<0.1%, and/or
other elements <2%, and/or the tungsten carbide(s) content is greater than 95% in percentage by mass based on the crystallized phases.

In a non-preferred embodiment, the content of cobalt Co and/or of nickel Ni and/or of elements other than W, C, Co, Ni, Ti, Ta, B, Cr, Nb, Mo, and V, and/or of zirconium Zr and/or of iron Fe is greater than 0.01%, or even greater than 0.05%.

Preferably, a ball according to the invention has a sphericity greater than 0.80, preferably greater than 0.85, preferably greater than 0.90, preferably greater than 0.92, preferably greater than 0.94, preferably greater than 0.95.

A ball according to the invention, preferably a powder according to the invention, has a tungsten carbide(s) content preferably greater than 60%, preferably greater than 65%, preferably greater than 70%, preferably greater than 75%, preferably greater than 80%, preferably greater than 85%, preferably greater than 87%, preferably greater than 90%, preferably greater than 92%, preferably greater than 94%, preferably greater than 95%, preferably greater than 97%, preferably greater than 98%, in percentage by mass based on the mass of the crystallized phases.

In an embodiment, in particular when in step b) a B₄C powder is present in the feedstock in an amount greater than 0.01%, preferably greater than 0.1% in percentage by mass based on the mass of the feedstock, and when said feedstock contains a total content of titanium carbide powder, of tantalum carbide powder, of chromium carbide powder, of niobium carbide powder, of molybdenum carbide powder and of vanadium carbide powder of less than 0.1%, in percentage by mass based on the mass of the feedstock, a ball according to the invention, preferably a powder according to the invention, has a tungsten carbide(s) content preferably greater than 60%, preferably greater than 65%, in percentage by mass based on the mass of the crystallized phases of the ball, preferably of the powder respectively, the balance of the tungsten carbide(s) being composed for more than 70%, preferably for more than 90% of its mass, of tungsten boride.

In an embodiment, in particular when in step b) the feedstock contains a total content of titanium carbide powder, of tantalum carbide powder, of chromium carbide powder, of niobium carbide powder, of molybdenum carbide powder and of vanadium carbide powder greater than 0.2%, in percentage by mass based on the mass of the feedstock, and said feedstock contains less than 0.01% of a B₄C powder, in percentage by mass based on the mass of the feedstock, a ball according to the invention, preferably a powder according to the invention, has a tungsten carbide(s) content preferably greater than 80%, preferably greater than 85%, preferably greater than 87%, preferably greater than 90%, preferably greater than 92%, preferably greater than 94%, preferably greater than 95%, preferably greater than 97%, preferably greater than 98%, in percentage by mass based on the mass of the crystallized phases of the ball, preferably of the powder respectively.

The WC and W₂C phases together represent, preferably more than 55%, preferably more than 60%, preferably more than 65%, preferably more than 70%, preferably more than 75%, preferably more than 80%, preferably more than 85%, preferably more than 90%, preferably more than 95% of the mass of all the crystallized phases of a ball according to the invention, preferably of a powder according to the invention.

The WC phase preferably represents more than 50%, preferably more than 55%, preferably more than 60%, preferably more than 65%, preferably more than 70%, preferably more than 75%, preferably more than 80%, preferably more than 85%, preferably more than 90%, preferably more than 95% of the mass of all the crystallized phases of a ball according to the invention, preferably of a powder according to the invention.

The ratio of the mass contents of the WC and W₂C phases on the basis of all the crystallized phases of a ball according to the invention, preferably of a powder according to the invention, WC/W₂C, is preferably greater than 2, preferably greater than 3, preferably greater than 4.

In an embodiment, the WC/W₂C ratio is preferably less than 40, preferably less than 35, or even less than 30, or even less than 25, or even less than 20, or even less than 15.

A ball according to the invention has an average grain size greater than or equal to 0.1 μm, preferably greater than or equal to 0.2 μm, greater than or equal to 0.5 μm and/or less than or equal to 30 μm, preferably less than or equal to 20 μm, preferably less than or equal to 17 μm, preferably less than or equal to 15 μm, preferably less than or equal to 12 μm. In an embodiment, the ball has an average grain size greater than or equal to 0.1 μm, preferably greater than or equal to 0.2 μm, greater than or equal to 0.5 μm and less than or equal to 4 μm, preferably less than or equal to 3 μm, preferably less than or equal to 2 μm, preferably less than or equal to 1.5 μm. In an embodiment, the ball has an average grain size greater than 4 μm, preferably greater than or equal to 5 μm and less than or equal to 30 μm, preferably less than or equal to 20 μm, preferably less than or equal to 17 μm, preferably less than or equal to 15 μm, preferably less than or equal to 12 μm.

A ball according to the invention has a surface pore density, measured on images taken by scanning electron microscopy, of less than 6%, preferably less than 4%, preferably less than 2%, preferably less than 1%, preferably less than 0.5%.

A ball according to the invention, preferably a powder according to the invention, preferably has a bulk density greater than or equal to 14.3 g/cm³, preferably greater than or equal to 14.6 g/cm³, preferably greater than or equal to 15 g/cm³.

A ball according to the invention preferably has a maximum Ferret diameter of less than 2 mm, preferably less than 1.5 mm, preferably less than 1 mm, preferably less than 800 μm.

### Ball Powder

The invention also relates to a powder comprising, in percentage by mass, more than 90%, preferably more than 93%, preferably more than 95%, preferably more than 97%, preferably more than 99%, preferably substantially 100% balls.

The median sphericity of the ball powder is preferably greater than 0.80, preferably greater than 0.85, preferably greater than 0.90, preferably greater than 0.92, preferably greater than 0.94, preferably greater than 0.95, preferably greater than 0.97, preferably greater than 0.98. Advantageously, the energy required for milling is reduced.

The ball powder preferably has a maximum size of less than 2 mm, preferably less than 1.5 mm, preferably less than 1 mm, preferably less than 800 μm.

The ball powder preferably has a median size D₅₀ of less than 1.8 mm, preferably less than 1.5 mm, preferably less than 1 mm, preferably less than 600 μm, and/or preferably greater than 10 μm, preferably greater than 20 μm, preferably greater than 30 μm. Such median sizes are particularly well suited for wet dispersion applications.

The ball powder has a ratio (D₉₀+D₁₀)/D₅₀ preferably less than 0.5, preferably less than 0.4, preferably less than 0.3, preferably less than 0.2, preferably less than 0.1. Advantageously, the separation of the balls and the suspension to be milled is facilitated.

### Examples

The following non-limiting examples are given for the purpose of illustrating the invention.

### Measurement Protocols

The following methods were used to determine certain properties of different sintered ball powders.

To determine the sphericity of a ball, the smallest and largest Ferret diameters are measured on a Camsizer® XT marketed by the firm Horiba.

The quantification of the elements present in the chemical composition of the sintered balls according to the invention is carried out:
for carbon, using a carbon-sulfur analyzer model EMIA-820V marketed by the firm HORIBA;
for oxygen, using an oxygen-nitrogen analyzer model ON836 marketed by the firm LECO;
for boron, by inductively coupled plasma (ICP) of a solution obtained according to the following method. The sintered balls to be analyzed first undergo a calcination in air at 650° C. for 4 hours. Then 700 mg of said calcined balls are mixed with 3 g of sodium carbonate and heated to 950° C. for a holding time at this temperature equal to 15 minutes. After cooling, the mixture obtained is added to 200 cm³ of demineralized water and to 10 cm³ of a 30 vol % hydrochloric acid solution, then the whole is brought to 200° C. under stirring so as to dissolve the mixture. The solution obtained is then filtered and made up to 500 ml using demineralized water so as to obtain the solution to be assayed by ICP;
for elements other than boron, oxygen and carbon, by X-ray fluorescence on a bead obtained by melting a mixture of 5 g of lithium tetraborate and of 500 mg of sintered balls to be analyzed having first undergone calcination in air at 650° C. for 24 hours, the determination of the element contents being carried out on the assumption that said calcination has oxidized all the elements present in the balls to be analyzed and that said balls no longer contain carbon after said calcination.

The quantification of the crystallized phases present in the sintered balls according to the invention is carried out directly on the balls, said balls being bonded on a self-adhesive carbon pellet, so that the surface of said pellet is maximally covered with balls.

The crystallized phases present in the sintered balls according to the invention are measured by X-ray diffraction, for example by means of an apparatus of the X'Pert PRO diffractometer type from the firm Panalytical equipped with a copper DX tube. The acquisition of the diffraction pattern is carried out from this equipment, over an angular range 20 comprised between 5° and 80°, with a pitch of 0.017°, and a counting time of 150 s/pitch. The front optics include a programmable divergence slit used fixed of ¼°, Soller slits of 0.04 rad, a mask equal to 10 mm and a fixed anti-scatter slit of ½°. The sample is rotated on itself in order to limit preferential orientations. The rear optics include a programmable anti-scatter slit used fixed of ¼°, a Soller slit of 0.04 rad and a Ni filter.

The diffraction patterns were then analyzed qualitatively using the EVA software and the ICDD2016 database.

Once the phases present were detected, the diffraction patterns were analyzed quantitatively with the High Score Plus software by Rietveld refinement according to the following conventional strategy, the possible peaks coming from the carbon pellet not being taken into account in the refinement:
a refinement of the background signal is carried out using the function “treatment”, “determine background” with the following choices: “bending factor” equal to 0 and “granularity” equal to 40;
conventionally, the ICDD sheets of the detected and quantifiable phases present are selected, and thus taken into account in the refinement;
an automatic refinement is then carried out by selecting the background signal previously determined “use available background” and by selecting the mode “automatic: option phase fit-default Rietveld”;
a manual refinement is then carried out if minority phases have not been taken into account in the automatic refinement;
a manual refinement of the parameter “Peak Shape 1” of the WC phase is carried out if this phase is the main phase;
finally, the parameter “B overall” of all selected phases is manually carried out simultaneously.

The bulk density of the balls was determined on a ball powder using a helium pycnometer (AccuPyc 1330 from the firm Micromeritics®), using the conventional method based on the measurement of the volume of helium displaced.

Particle size analyses were performed using a Camsizer® XT marketed by the firm Horiba.

The mean grain size of the sintered balls was measured by the Mean Linear Intercept method. A method of this type is described in standard ASTM E1382. According to this standard, analysis lines are drawn on images of the balls and then along each analysis line the lengths, called “intercepts”, between two consecutive grain boundaries intersecting said analysis line are measured.

The average length “l” of the intercepts “I” is then determined.

The average grain size “d” of the sintered balls of the powder is given by the relation: d=1.56·l′. This formula is derived from formula (13) of “Average Grain Size in Polycrystalline Ceramics” M. I. Mendelson, J. Am. Cerm. Soc. Vol. 52, No. 8, pp 443-446.

The surface pore density of the sintered balls was measured by the following method. Images of polished surfaces of sections of the sintered balls are made using a scanning electron microscope, so that each image contains between 20 and 50 grains. The number of images taken is such that the entire surface covered represents about 100 grains. The surface covered by the grains, Si, and the surface covered by the pores Sₚᵢ is calculated for each of the images i. The total surface covered by the grains S_{GT} is equal to the sum of the surface covered by the grains, S_{Gi}, on each of the images i. The total surface covered by the pores S_{PT} is equal to the sum of the surface covered by the pores, Sₚᵢ, in each image i. The surface pore density, expressed as a percentage, is equal to S_{PT}/(S_{GT}+S_{PT}).

### Manufacturing Protocol

The sintered balls of example 1 are “Tungsten carbide” sp. gr. 15 “WC” balls, distributed by the firm GlenMills®, having a median size equal to 500 μm.

The sintered balls of example 2 were prepared from a tungsten carbide powder containing more than 99% tungsten carbide WC and having a median size, measured by means of a laser particle size analyzer, equal to 0.4 μm.

A feedstock consisting of 300 g of tungsten carbide powder is introduced into a granulator plate having a diameter equal to 40 cm and rotating at 30 rpm. During rotation, 20 g of a solution of demineralized water and 1% polyvinyl alcohol (PVA) is gradually sprayed, until seeds are formed. Once the seeds have formed, 500 g of tungsten powder is gradually added while 40 g of the solution of demineralized water and 1% polyvinyl alcohol (PVA) is gradually sprayed on, so that the seeds grow until raw balls of the desired size are obtained.

The raw balls obtained are then unloaded, air-dried for 24 h at 110° C. before being sintered at 2200° C. for a plateau time of 2 hours, under argon, with a temperature increase rate and a temperature decrease rate equal to 300° C./h. After sintering, the sintered balls are sieved and the 400-600 μm grain size range is retained.

The sintered balls of examples 3 to 6 were prepared from:
a tungsten carbide powder comprising more than 99% tungsten carbide WC and having a median size, measured by means of a laser particle size analyzer, equal to 0.4 μm for examples 3 to 5,
a tungsten carbide powder comprising more than 99% tungsten carbide WC and having a median size, measured by means of a laser particle size analyzer, equal to 1.5 μm for example 6,
a TiC powder, having an element O content equal to 0.7%, a total carbon content equal to 19.4% and a content of elements other than O, Ti and C of less than 0.3%, and having a median size, measured by means of a laser particle size analyzer, equal to 2.5 μm for example 4,
a B₄C powder, having an element O content equal to 2.3%, a total carbon content equal to 21.8%, and a content of elements other than O, B and C of less than 0.4%, and having a median size, measured by means of a laser particle size analyzer, equal to 2.8 μm for examples 5 and 6.

For example 3, 200 g of WC powder is placed in a high-density polyethylene jar with a volume equal to 0.5 l and a diameter equal to 10 cm. The jar is rotated on a jar turner at a speed equal to 60 rpm for 48 hours. The granules formed are recovered and sintered at 2250° C. for a plateau time of 2 hours, under argon, with a temperature increase rate and a temperature decrease rate equal to 300° C./h. After sintering, the sintered balls are sieved and the 100-600 μm grain size range is retained.

For example 4, 198 g of WC powder, 2 g of TiC powder and 60 g of demineralized water are mixed in a paddle mixer for 1 hour so as to obtain a suspension. The suspension is then transferred to a high-density polyethylene jar, and said jar is immersed in a bath of liquid nitrogen to freeze the suspension.

After freezing, the water is removed by vacuum sublimation (freeze-drying).

The recovered powder is then deagglomerated with an agate mortar. 200 g of said powder is placed in a 0.5 l high-density polyethylene jar with a diameter equal to 10 cm. The jar is rotated on a jar turner at a speed equal to 60 rpm for 48 hours. The granules formed are recovered and sintered at 2250° C. for a plateau time of 2 hours, under argon, with a temperature increase rate and a temperature decrease rate equal to 300° C./h. After sintering, the sintered balls are sieved and the 100 μm-600 μm grain size range is retained.

The balls of examples 5 and 6 are made according to the same process as that implemented to obtain the balls of example 4, the mixture of 198 g of WC powder and 2 g of TiC powder being replaced by a mixture of 199 g of WC powder and 1 g of B₄C powder, the balls according to example 6 being sintered at a temperature equal to 2100° C.

### Results

The results obtained are summarized in Table 1 below.

TABLE 1

| | | Example | | | | | |
|---|---|---|---|---|---|---|---|
| | | 1 | 2 | 3 | 4 | 5 | 6 |
| Chemical composition, in | W | 87.2 | 93.6 | 93.7 | 92.9 | 93.5 | 93.5 |
| percentage by mass based | C | 6 | 6 | 6.1 | 6.1 | 6 | 6 |
| on the mass of the sintered | Co | 5.4 | 0.01 | <0.05 | <0.05 | <0.05 | <0.05 |
| balls | Ni | 1 | <0.1 | <0.05 | <0.05 | <0.05 | <0.05 |
| | Other elements | 0.4 | <0.39 | 0.2 | 1 | 0.5 | 0.5 |
| | Of which Zr | n.d. | <0.05 | <0.07 | <0.07 | <0.07 | <0.07 |
| | Of which Ti | n.d. | n.d. | <0.1 | 0.8 | <0.1 | <0.1 |
| | Of which Ta | n.d. | n.d. | <0.1 | <0.1 | <0.1 | <0.1 |
| | Of which B | n.d. | n.d. | <0.01 | <0.01 | 0.30 | 0.29 |
| Content of crystallized | Tungsten carbide(s) | 95 | 100 | 100 | 89 | 62 | 89 |
| phases, in percentage by | WC | 95 | 97 | 98 | 53 | 62 | 89 |
| mass based on the mass of | W₂C | 0 | 3 | 2 | 0 | 0 | 0 |
| the crystallized phases of | Other phases | 5 | 0 | 0 | 47 | 38 | 11 |
| the sintered balls | Of which phase containing | 5 | 0 | 0 | 0 | 0 | 0 |
| | Co | 0 | 0 | 0 | 0 | 38 | 11 |
| | Of which WB | 0 | 0 | 0 | 36 | 0 | 0 |
| | Of which W and Ti carbide | 0 | 0 | 0 | 11 | 0 | 0 |
| | of cubic structure | | | | | | |
| | Of which graphite | | | | | | |
| Other features | Bulk density (g/cm³) | 15.1 | 15 | 15.4 | 14.7 | 15.3 | 15.2 |
| | Average grain size (μm) | 1 | 1.6 | n.d. | 1.7 | 6.9 | 6 |
| | Median sphericity of the | 0.97 | 0.91 | 0.95 | 0.93 | 0.92 | 0.93 |
| | ball powder | | | | | | |
| | D₅₀ of the ball powder (μm) | 500 | 440 | 410 | 275 | 260 | 290 |
| | Surface pore density (%) | 0 | n.d. | 1 | n.d. | 2.5 | 3 |

n.d. not determined

The microstructure of the balls of example 3 shows the presence of large grains with an elongated shape.

Furthermore, tests have shown that fused tungsten carbide balls (obtained by melting) can have cavity-like defects, making them more susceptible to breakage during use. The sintered balls according to the invention, which have a completely different microstructure than fused balls, are therefore preferred. Tests have shown good behavior of the balls according to the invention during milling.

The use of the balls according to the invention is not limited to the milling of materials. The balls according to the invention can also be used in the industries of paints, inks, dyes, magnetic lacquers, agrochemical compounds for the dispersion and homogenization of liquid and solid constituents, or as sprayed media in a surface treatment process.

What is claimed:

1. Use, as a milling agent for milling a suspension, wet dispersing agent or for surface treatment, of a powder comprising more than 90% by mass of sintered balls, each sintered ball having:
a chemical composition such that, in percentages by mass based on the mass of the ball:
89%≤W≤97%;
5%≤C≤8%;
Co≤0.5%;
Ni≤0.5%; and
Elements other than W, C, Co, and Ni, or “Other elements”: ≤3%;
a tungsten carbide(s) content greater than 55% in percentage by mass based on the crystallized phases; and
a bulk density greater than or equal to 14 g/cm³.

2. Use according to claim 1, in which the tungsten carbide(s) content in said sintered ball is greater than 80%, in percentage by mass based on the crystallized phases.

3. Use according to claim 1, in which, in said sintered ball, 0.01%<Ti+Ta+B+Cr+Nb+Mo+V<2.5%.

4. Use according to claim 1, in which, in said sintered ball:
W>90% and W<96%, and/or
C>5.5% and C<7.5%, and/or
Co<0.3%, and/or
Ni<0.3%, and/or
Fe<0.5%, and/or
other elements <2.5%, and/or
the tungsten carbide(s) content is greater than 85% in percentage by mass based on the crystallized phases.

5. Use according to claim 1, in which, in said sintered ball,
W<95%, and/or
C>5.9% and C<7%, and/or
Co<0.1%, and/or
Ni<0.1%, and/or
other elements <2%, and/or
the tungsten carbide(s) content is greater than 95% in percentage by mass based on the crystallized phases.

6. Use according to claim 1, said sintered ball having a bulk density greater than or equal to 14.3 g/cm³.

7. Use according to claim 1, said sintered ball having a bulk density greater than or equal to 14.6 g/cm³.

8. Use according to claim 1, in which, in said sintered ball, Zr<0.17%.

9. Use according to claim 1, in which, in said sintered ball, Zr<0.1%.

10. Use according to claim 1, in which, in said sintered ball, 0.2%<Ti<2.5%.

11. Use according to claim 1, in which, in said sintered ball 0.2%<Ta<2.5%.

12. Use according to claim 1, in which, in said sintered ball, 0.1%<Ti<1.5% and 0.2%<Ta<2%.

13. Use according to claim 1, in which, in said sintered ball, 0.01%<B<2.5%.

14. Use according to claim 1, said sintered ball having a sphericity greater than 0.90.

15. Use according to claim 1, in which, in said sintered ball, WC and W₂C together represent more than 85% of the mass of all the crystallized phases of the ball.

16. Use according to claim 1, said sintered ball having an average grain size greater than or equal to 0.1 μm and/or less than or equal to 30 μm.

17. Use according to claim 1, in which the powder has a median size D₅₀ of less than 1.8 mm and greater than 10 μm.

18. Use according to claim 1, in which, in said sintered ball, Co≤0.3% and/or Ni≤0.3%.

19. Use according to claim 1, in which, in said sintered ball, Co≤0.1% and/or Ni≤0.1%.

20. Use according to claim 1, in which, in said sintered ball, Co≤0.05% and/or Ni≤0.05%.

21. Use according to claim 1, in which the powder is manufactured according to a manufacturing process comprising the following steps:
a) Preparation of a feedstock so that the ball powder obtained at the conclusion of step c) is as claimed in claim 1,
b) Shaping of the feedstock into a raw ball powder, and
c) Sintering at a temperature greater than 1700° C. so as to obtain said powder.

22. Use according to claim 21, wherein the sintering temperature is greater than 1800° C.

23. Use according to claim 21, wherein the sintering is carried out at atmospheric pressure.

24. Use according to claim 21, wherein the feedstock comprises a WC powder and, optionally, one or more carbon, titanium carbide, tantalum carbide, boron carbide, vanadium carbide, molybdenum carbide, chromium carbide, niobium carbide and tungsten oxide powders, said powders which may be replaced, at least partially, by precursor powders, introduced in equivalent amounts, the median size of all the particles of said powders, preferably the median size of each said powder being less than 2 μm.

25. Use according to claim 24, wherein the median size of all the particles of the powders recited in claim 24, preferably the median size of each said powder is less than 1 μm.
